(19) United States
(12) Patent Application Publication
(10) Pub. No.: US 2026/0122406 A1
(43) Pub. Date: Apr. 30, 2026

(54) ADJUSTING NOISE CANCELLATION BASED ON DETECTED SPEECH

(71) Applicant: Motorola Mobility LLC, Chicago, IL (US)

(72) Inventors: Amit Kumar Agrawal, Bangalore (IN); Philip Weinstein, Apex, NC (US); Amal Chandran, Bengaluru (IN)

(73) Assignee: Motorola Mobility LLC, Chicago, IL (US)

(21) Appl. No.: 18/931,490

(22) Filed: Oct. 30, 2024

(51) Int. Cl. H04R 1/10; G10L 15/22; G10L 21/0208; G10L 25/84

(52) U.S. Cl. CPC H04R 1/1083; G10L 15/22; G10L 21/0208; G10L 25/84

(57) ABSTRACT

In aspects of adjusting noise cancellation based on detected speech, a client device implements an ANC manager that detects a headset employing active noise cancellation (ANC) during a call routed to the headset. The ANC manager detects audio received at a microphone associated with the headset and determines whether the audio received at the microphone indicates a user of the headset is speaking during the call. Based on whether the user of the headset is speaking during the call, the ANC manager adjusts the ANC.

### BACKGROUND

Headsets allow users to hear different audible media (e.g., call audio, music, podcasts, sound accompanying video, etc.) from mobile devices without that media interfering with others and/or while maintaining the confidentiality of the media. Active noise cancellation (ANC) for such headsets limits the amount of ambient noise heard by the users of the headsets, which, in turn, allows the users to better hear audible media or other sounds from the headsets. While ANC is generally a desirable feature of a headset, ANC may undesirable in some scenarios and/or environments. As such, most headsets that have ANC as a feature also have a mechanism for turning the ANC on or off, and that mechanism may be operated at the headset itself and/or by a mobile device that communicates with the headset. This mechanism generally allows an individual to manually turn on and adjust the ANC when desired and turn off the ANC when it is not desired.

### BRIEF DESCRIPTION OF THE DRAWINGS

Implementations of techniques for adjusting noise cancellation based on detected speech are described with reference to the following Figures. The same numbers may be used throughout to reference like features and components shown in the Figures.

FIG. 1 illustrates an example system for adjusting noise cancellation based on detected speech in accordance with one or more implementations as described herein.

FIG. 2 further illustrates an example of adjusting noise cancellation based on detected speech, including pausing the ANC, in accordance with one or more implementations as described herein.

FIG. 3 further illustrates an example of adjusting noise cancellation based on detected speech, including resuming the ANC, in accordance with one or more implementations as described herein.

FIG. 4 further illustrates an example of adjusting noise cancellation based on detected speech, including dynamically adjusting the ANC based on noise identification, in accordance with one or more implementations as described herein.

FIG. 5 further illustrates an example of adjusting noise cancellation based on detected speech, including dynamically adjusting the ANC based on a decibel level, in accordance with one or more implementations as described herein.

FIG. 6 is a flowchart illustrating an example of adjusting noise cancellation based on detected speech in accordance with one or more implementations as described herein.

FIG. 7 illustrates an example method for adjusting noise cancellation based on detected speech in accordance with one or more implementations of the techniques described herein.

FIG. 8 illustrates an example method for adjusting noise cancellation based on detected speech in accordance with one or more implementations of the techniques described herein.

FIG. 9 illustrates an example method for adjusting noise cancellation based on detected speech in accordance with one or more implementations of the techniques described herein.

FIG. 10 illustrates various components of an example device that may be used to implement the techniques for adjusting noise cancellation based on detected speech in accordance with one or more implementations as described herein.

### DETAILED DESCRIPTION

Implementations of the techniques for adjusting noise cancellation based on detected speech may be implemented as described herein. A headset, such as over-the-ear headphones, earbuds, ear pods, an earpiece, and/or any other type of headset, may be configured to perform the techniques for adjusting noise cancellation based on detected speech. In one or more implementations, the headset includes an ANC manager, which can be used to implement aspects of the techniques described herein.

Headsets can connect (e.g., wired or wirelessly) and communicate with a mobile device to allow a user to participate in an audio call without interrupting others and while maintaining privacy in public spaces. Many headsets are capable of active noise cancellation (ANC), which limits the amount of ambient noise heard by a user of a headset while in an “immersive mode,” and in turn, allows the user to better hear the audio from the call or other sounds from the headset.

However, while ANC is generally a convenient feature of a headset, ANC presents some disadvantages. Employing the ANC is helpful to the user when listening to the call audio or other audio playback using the headset because the ANC reduces the ambient noise and allows the user to focus on listening to the caller. However, the ANC makes it uncomfortable to speak during the call. This is because the user hears their voice with no ambient noise, and the user's voice sounds strange to the user when unaccompanied by ambient noise. Conventional solutions involve a mechanism for adjusting the ANC, which generally allows the user to manually actuate the ANC to “immersive mode” when desired and turn off the ANC to “ambient mode” when it is not desired. However, this conventional solution is inconvenient because the user must manually adjust, turn on, or turn off the ANC.

Techniques and systems are described for adjusting noise cancellation based on detected speech that overcome these limitations. In aspects of the described techniques, an ANC manager is implemented in a headset, a mobile device, or in a combination of both. The ANC manager adjusts the ANC when the user is speaking on the call. For example, the ANC manager may pause the ANC, decrease a level of the ANC, or dynamically adjust the ANC while the user is speaking on the call so that the user may hear the ambient noise while speaking. This results in a more comfortable call because the user hears the ambient noise while speaking.

To begin, the ANC manager detects that the headset is actively receiving call audio while also causing ANC, which limits the amount of external noise heard by a user wearing the headset. The ANC manager monitors the audio from the environment received at the microphone for detected speech from the user. In some implementations, for instance, the ANC manager receives input audio from the microphone associated with the headset. Because the microphone may receive a mix of ambient noise and the user's speech, the ANC manager may use voice recognition to determine whether the user is actively speaking.

After detecting that the user is actively speaking, the ANC manager performs an ANC adjustment. The ANC adjustment may involve pausing the ANC, decreasing a level of the ANC, or dynamically adjusting the ANC. For instance, pausing the ANC may involve ending the ANC entirely. The ANC adjustment may continue until the ANC manager determines that the user is no longer speaking. In contrast, decreasing a level of the ANC may involve an overall decrease in the perceived strength of the ANC, thereby allowing a predetermined level of ambient noise to be heard by the user while the user is speaking.

In situations involving dynamically adjusting the ANC, the ANC manager cancels some noises while allowing the user to hear other noises, which is otherwise referred to as “adaptive transparency mode.” In an example, air conditioning noise, which is relatively constant and less distracting, is not canceled by the ANC. Conversely, noise from a dog barking is more distracting and therefore is canceled by the ANC. The determination of which noises are canceled and which noises are not canceled may be predetermined, based on comparative decibel levels, or based on any other methodology. In some implementations, for example, the ANC manager may employ a noise identification algorithm to determine which noises to dynamically cancel.

The described techniques for adjusting noise cancellation based on detected speech overcome the limitations of conventional systems. For example, automatically adjusting the ANC while the user is speaking on the call provides a more comfortable user experience because it allows the user to hear ambient noise in the background while speaking during the call, while also enjoying distraction-free listening without ambient noise while not talking during the call. Adjusting noise cancellation based on detected speech also alleviates user frustration by minimizing the need for manual ANC adjustments using conventional systems that involve an adjustment mechanism.

While features and concepts of the described techniques for adjusting noise cancellation based on detected speech is implemented in any number of different devices, systems, environments, and/or configurations, implementations of the techniques for adjusting noise cancellation based on detected speech are described in the context of the following example devices, systems, and methods.

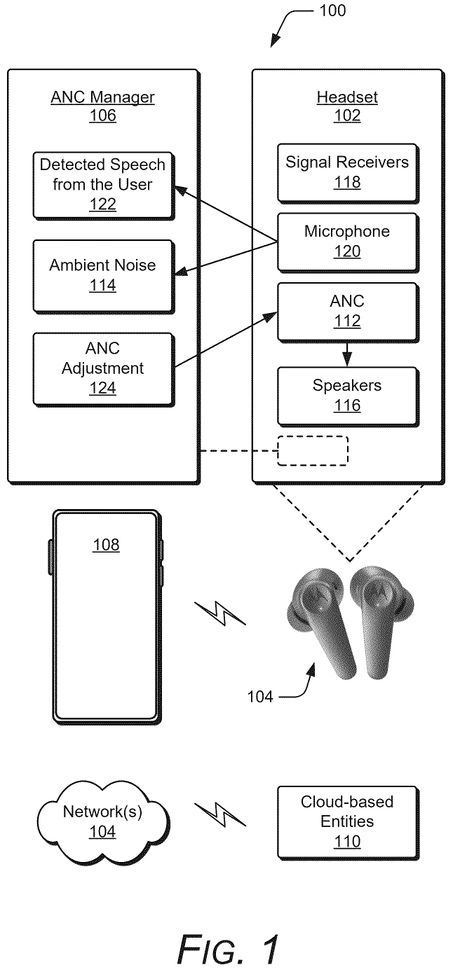

FIG. 1 illustrates an example system 100 for adjusting noise cancellation based on detected speech. The system 100 includes a headset 102, a communication network 104, and an ANC manager 106. Examples of the headset 102 can include over-the-ear headphones, earbuds, ear pods, an earpiece, and/or any other type of headset having or implemented with the ANC feature. Additionally, the headset 102 may be wired or wireless.

In some implementations, the headset 102 is paired with a mobile device 108. Examples of the mobile device 108 include any type of a wireless device, mobile device, mobile phone, flip phone, client device, companion device, tablet, computing device, communication device, entertainment device, gaming device, media playback device, any other type of computing, consumer, and/or electronic device.

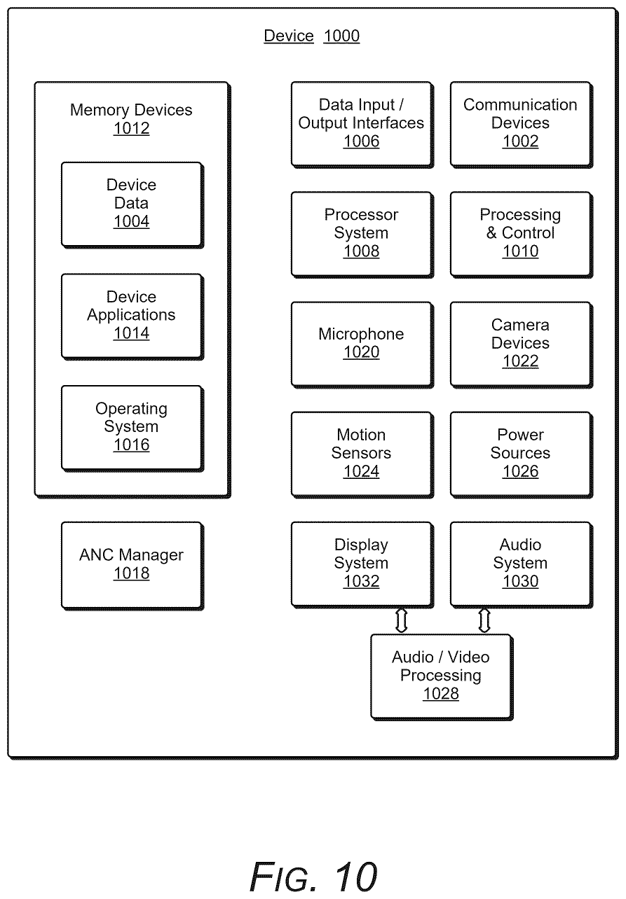

The mobile device 108 can be implemented with various components, such as a processor system and memory, as well as any number and combination of different components as further described with reference to the example device shown in FIG. 10. In implementations, the mobile device 108 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a WiFi radio, a cellular radio, a global positioning satellite (GPS) radio, or any available type of device communication interface.

In some example implementations, the devices, applications, modules, servers, and/or services described herein communicate via the communication network 104, such as for data communication between the mobile device 108 and various cloud-based entities 110, such as devices, services, servers, and/or systems in the network cloud. The communication network 104 can include a wired and/or a wireless network. The communication network 104 is implemented using any type of network topology and/or communication protocol and is represented or otherwise implemented as a combination of two or more networks, to include IP-based networks, cellular networks, and/or the Internet. The communication network 104 can include mobile operator networks that are managed by a mobile network operator and/or other network operators, such as a communication service provider, mobile phone provider, and/or Internet service provider.

The headset 102 and/or the mobile device 108 includes various functionality that enables the device to implement different aspects of adjusting noise cancellation based on detected speech. In the illustrated example, the headset 102 is configured to cause active noise cancellation (ANC) 112 (e.g., implemented as a feature, module, software, firmware, and/or the like) and includes one or more speakers 116, one or more signal receivers 118, and one or more microphones 120. The ANC 112 can be implemented with any of a variety of ANC technologies. Typically, the ANC 112 causes the headset 102 to emit sound waves that are opposite to ambient noise 114 in the environment, thereby cancelling at least a portion of the ambient noise 114. For more sophisticated ANC, the one or more microphones 120 receive the ambient noise 114 to aid in producing sound waves that are opposite to the ambient noise 114. The one or more speakers 116 can be any of a variety of speakers suitable for use in the headset 102, such as dynamic drivers. The signal receiver 118 can be a wireless and/or Bluetooth receiver and/or can be a receiver for a wired connection. As such, the headset 102 can be a wired headset or a wireless headset, and the headset 102 may be implemented for audio communication with the mobile device 108. In a typical scenario, the headset 102 receives signals from the mobile device 108 and produces sound at the one or more speakers 116 of the headset 102. At the same time, when activated, the ANC 112 would cause the one or more speakers 116 to send out sounds waves for cancelling the ambient noise 114.

In the example system 100 for adjusting noise cancellation based on detected speech, the mobile device 108 and/or the headset 102 implements the ANC manager 106 (e.g., as a device application). As shown in this example, the ANC manager 106 represents functionality (e.g., logic, software, and/or hardware) enabling aspects of the described techniques for adjusting noise cancellation based on detected speech. The ANC manager 106 can be implemented as computer instructions stored on computer-readable storage media and can be executed by a processor system of the headset 102 and/or the mobile device 108. Alternatively, or in addition, the ANC manager 106 can be implemented at least partially in hardware of the headset 102 and/or the mobile device 108.

In one or more implementations, the ANC manager 106 includes independent processing, memory, and/or logic components functioning as a computing and/or electronic device integrated with the headset 102 and/or the mobile device 108. Alternatively, or in addition, the ANC manager 106 can be implemented in software, in hardware, or as a combination of software and hardware components. In this example, the ANC manager 106 is implemented as a software application or module, such as executable software instructions (e.g., computer-executable instructions) that are executable with a processor system of the headset 102 and/or the mobile device 108 to implement the techniques and features described herein. As a software application or module, the ANC manager 106 can be stored on computer-readable storage memory (e.g., memory of a device), or in any other suitable memory device or electronic data storage implemented with the controller. Alternatively or in addition, the ANC manager 106 can be implemented in firmware and/or at least partially in computer hardware. For example, at least part of the ANC manager 106 is executable by a computer processor, and/or at least part of the content manager is implemented in logic circuitry. In at least one implementation the ANC manager 106 can be implemented as part of and/or in conjunction with an operating system of the mobile device 108 and/or the headset 102.

In this example system 100, the ANC manager 106 performs operations for adjusting noise cancellation based on detected speech by first detecting that the headset 102 is actively engaged in a call and performing ANC 112. In some implementations, this may involve detecting that the headset 102 is in communication with the mobile device 108 that is routing call audio to the headset 102. For example, the headset 102 may be causing ANC and outputting audio playback communicated from the mobile device 108. In this example, the audio playback includes call audio from an audio call performed by a user wearing the headset 102. The ANC 112 cancels the ambient noise 114 in the environment, so the user is likely unable to hear external noise, other than the audio playback.

Employing the ANC 112 is helpful to the user when listening to the call audio using the headset 102 because the ANC 112 reduces the ambient noise 114 and allows the user to focus on listening to the caller. However, the ANC 112 makes it uncomfortable to speak during the call. This is because the user hears their voice with no background noise, and the user's voice sounds strange when unaccompanied by other noise.

To address this problem, the ANC manager 106 adjusts the ANC 112 when the user is speaking on the call. For example, the ANC manager 106 may pause the ANC 112, decrease a level of the ANC 112, or dynamically adjust the ANC 112 while the user is speaking on the call so that the user may hear the ambient noise 114 while speaking. This results in a more comfortable call because the user hears the ambient noise 114 while speaking, which helps to dilute the effect of listening to the user's own voice.

The ANC manager 106 begins in this example by monitoring the audio in the environment received at the microphone 120 for detected speech 122 from the user. In some implementations, for instance, the ANC manager 106 receives input audio from the microphone 120 associated with the headset 102. Because the microphone 120 may receive a mix of ambient noise and the user's speech, the ANC manager 106 may use voice recognition to identify the user's speech and to determine whether the user is actively speaking.

After detecting that the user is actively speaking, the ANC manager 106 performs an ANC adjustment 124. For instance, the ANC manager 106 pauses the ANC 112, decreases a level of the ANC 112, or dynamically adjusts the ANC 112. Pausing the ANC 112 may involve ending the ANC 112 entirely while the user is speaking. Decreasing a level of the ANC 112 may involve partially filtering the ambient noise 114 to allow a lower volume level of the ambient noise 114 to be output by the one or more speakers 116 of the headset 102. The ANC adjustment 124 continues until the ANC manager 106 determines that the user is no longer speaking.

In situations involving dynamically adjusting the ANC 112, the ANC manager 106 determines which noises are allowed to disturb or interrupt the user based on a context of the audio source. For instance, some noises are canceled by the ANC 112 and other noises are not canceled. In an example, car noise, which is relatively constant and less distracting, is allowed and is therefore not canceled by the ANC 112. Conversely, noise from a dog barking is more distracting and therefore is canceled by the ANC 112. The determination of which noises are canceled and which noises are not canceled may be predetermined, based on comparative decibel levels, or based on any other methodology. In some implementations, for example, the ANC manager 106 may employ a noise identification algorithm to determine which noises to cancel.

In one or more implementations, the ANC manager 106 can be implemented with, or to use or leverage, a machine learning (ML) model or algorithm (e.g., a neural network, artificial intelligence (AI) algorithms). The ANC manager 106 implemented as a machine learning model may include AI, a ML model or algorithm, a convolutional neural network (CNN), and/or any other type of machine learning model to implement features of adjusting noise cancellation based on detected speech. As used herein, the term “machine learning model” refers to a computer representation that is trainable based on inputs to approximate unknown functions. For example, a machine learning model can utilize algorithms to learn from, and make predictions on, inputs of known data (e.g., training and/or reference images) by analyzing the known data to learn to generate outputs. In the example system 100, the ANC manager 106 can determine when the user is speaking and/or which specific noises to filter using the ANC 112 while the user is speaking.

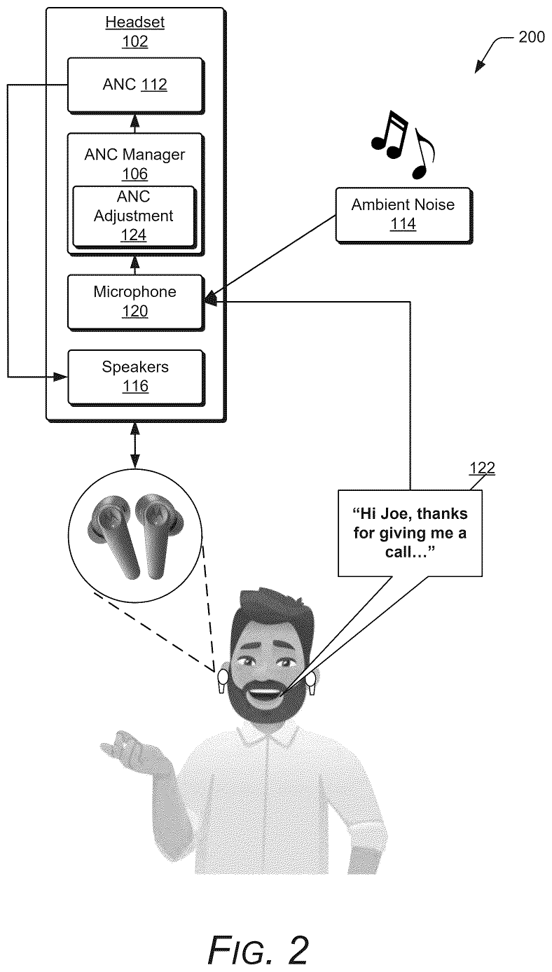

FIG. 2 illustrates an example 200 of adjusting noise cancellation based on detected speech, including pausing the ANC, as described herein. In this example 200, an ANC manager 106 is implemented in a headset 102, and the ANC manager 106 detects that the headset 102 is actively causing active noise cancellation (ANC) 120 that cancels the ambient noise 114 in the environment, resulting in the user being unable to hear external noise.

As illustrated in this example, a user is wearing the headset 102 to participate in a call. The headset 102 includes one or more speakers 116 for outputting audio playback from the call and a microphone 120 for receiving input audio to transmit for the call. For example, the headset 102 may be paired with a mobile device 108 that performs functions of the call, and the input audio is routed from the microphone 120 of the headset 102 to the mobile device 108, while the output audio is routed from the mobile device 108 to the one or more speakers 116 of the headset 102 for playback.

The headset 102 actively performs ANC 112 during the call. In some examples, the ANC 112 may be automatically initiated when the headset 102 is worn, manually initiated, or automatically initiated at the start of a call. To perform the ANC 112, the ANC manager 106 causes the headset 102 to emit sound waves that are opposite to ambient noise 114 in the environment, thereby cancelling at least a portion of the ambient noise 114. In some implementations, the one or more microphones 120 may receive the ambient noise 114 to aid in producing sound waves that are opposite to the ambient noise 114. The one or more speakers 116 can be any of a variety of speakers suitable for use in the headset 102, such as dynamic drivers. The signal receiver 118 can be a wireless and/or Bluetooth receiver and/or can be a receiver for a wired connection. As such, the headset 102 can be a wired headset or a wireless headset and implemented for audio communication with the mobile device 108. In a typical scenario, the headset 102 receives signals from the mobile device 108 and produces sound from the one or more speakers 116. At the same time, when activated, the ANC 112 would cause the one or more speakers 116 to send out sounds waves for cancelling the ambient noise 114.

In this example, for instance, the user is inside a restaurant, and the ambient noise 114 is background music. To cancel the background music so that it does not interfere with the user hearing audio from the call, the ANC manager 106 causes the headset 102 to emit sound waves that are opposite to ambient noise 114 in the environment, thereby cancelling at least a portion of the ambient noise 114.

However, it is now the user's turn to speak during the call. Although the ANC 112 helps reduce distractions by canceling the ambient noise 114 while the user is listening on the call, the lack of the ambient noise 114 creates an uncomfortable experience when the user is speaking on the call. This is because the user hears their voice in a vacuum unaccompanied by any other sound, which users typically do not enjoy. To solve this problem, the ANC manager 106 performs an ANC adjustment 124 while the user is speaking.

The ANC manager 106 first determines when the user is speaking on a call. To do this, the ANC manager 106 engages the microphone 120, which may be kept on low power to detect speech from the user. In some example implementations, the ANC manager 106 employs a voice recognition model to differentiate user speech received at the microphone 120 from the ambient noise 114. The voice recognition model may digitize information received by the microphone 120 and use a machine learning algorithm that matches sounds from the information to known sounds from the user.

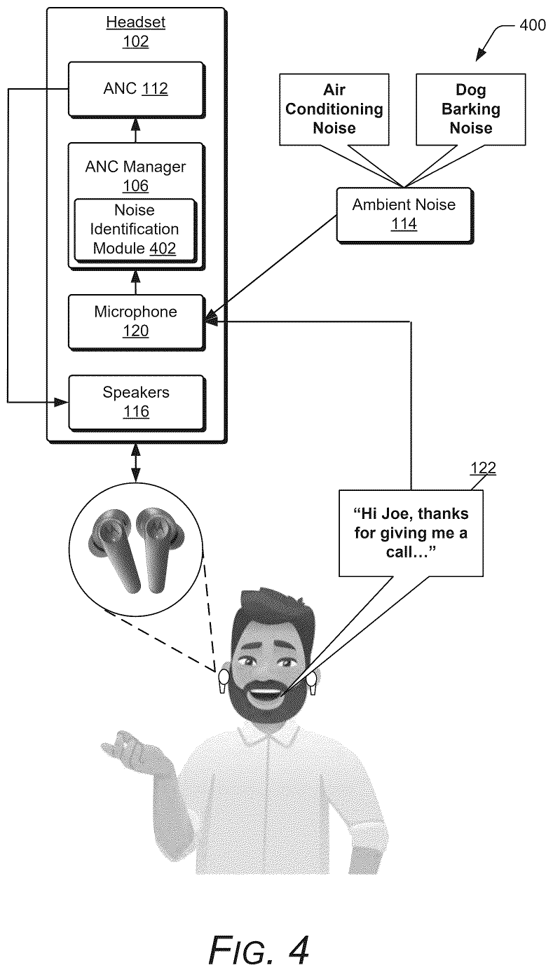

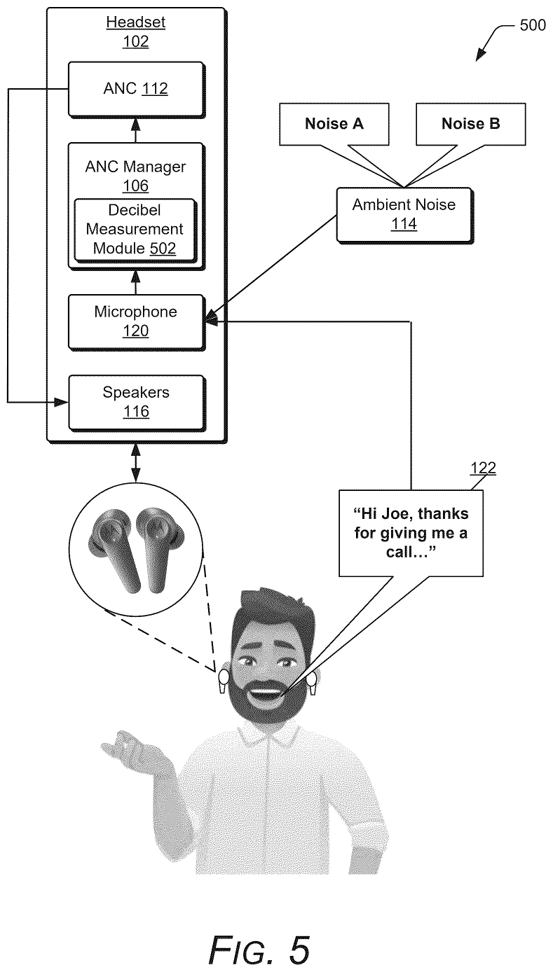

As illustrated in this example, the user is engaged in a call using the headset 102. The user then says “Hi Joe, thanks for giving me a call . . . ” The ANC manager 106 therefore detects that the user is speaking during the call to initiate the ANC adjustment 124. In this example implementation, the ANC adjustment 124 involves pausing the ANC 112 while the user is speaking. For instance, the ambient noise 114 is no longer filtered by the ANC 112 and can therefore be heard by the user while the user is speaking. The ANC adjustment 124 is explained in further detail with respect to FIGS. 4 and 5. Because of the ANC adjustment 124, the user experiences a more comfortable call because the user hears ambient noise 114 while the user is speaking.

In this example implementation, once the user concludes speaking, the ANC manager 106 resumes the ANC 112. For example, the ANC 112 resumes so that the ANC 112 causes the headset 102 to emit sound waves that are opposite to ambient noise 114 in the environment, thereby cancelling at least a portion of the ambient noise 114.

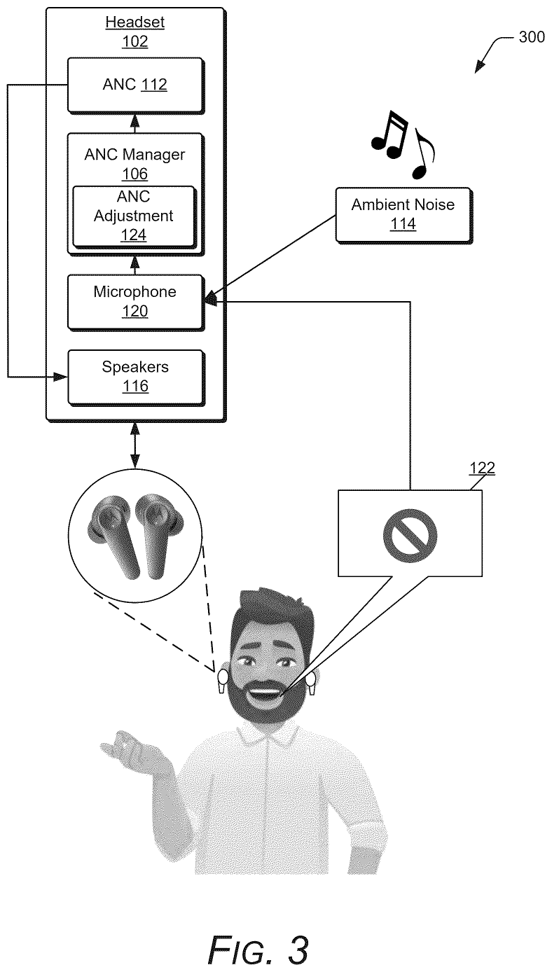

FIG. 3 illustrates an example 300 of adjusting noise cancellation based on detected speech, including resuming the ANC, as described herein. In this example 300, an ANC manager 106 is implemented in a headset 102, and the ANC manager 106 detects that the headset 102 is actively causing active noise cancellation (ANC) 120 that cancels the ambient noise 114 in the environment, resulting in the user being unable to hear external noise.

As illustrated in this example, a user is wearing the headset 102 to participate in a call. The headset 102 includes one or more speakers 116 for outputting audio playback from the call and a microphone 120 for receiving input audio to transmit for the call. For example, the headset 102 may be paired with a mobile device 108 that performs functions of the call, and the input audio is routed from the microphone 120 of the headset 102 while the output audio is routed to the one or more speakers 116 for playback.

The headset 102 actively performs ANC 112 during the call. In some examples, the ANC 112 may be automatically initiated when the headset 102 is worn, manually initiated, or automatically initiated at the start of a call. To perform the ANC 112, the ANC manager 106 causes the headset 102 to emit sound waves that are opposite to ambient noise 114 in the environment, thereby cancelling at least a portion of the ambient noise 114.

In this example, for instance, the user is inside a restaurant, and the ambient noise 114 is background music. To cancel the background music so that it does not interfere with the user hearing audio from the call, the ANC manager 106 causes the headset 102 to emit sound waves that are opposite to ambient noise 114 in the environment, thereby cancelling at least a portion of the ambient noise 114.

Although the ANC 112 helps reduce distractions by canceling the ambient noise 114 while the user is listening on the call, the lack of the ambient noise 114 creates an uncomfortable experience when the user is speaking on the call. This is because the user hears their voice in a vacuum unaccompanied by any other sound, which users typically do not enjoy. To solve this problem, the ANC manager 106 performs an ANC adjustment 124 while the user is speaking. While the user is not speaking (i.e. listening) in the call, however, the ANC 112 resumes and cancels the ambient noise 114.

To determine whether to commence the ANC adjustment 124, the ANC manager 106 first determines when the user is speaking on a call. In some example implementations, the ANC manager 106 employs a voice recognition model to differentiate user speech received at the microphone 120 from the ambient noise 114. The voice recognition model may digitize information received by the microphone 120 and use a machine learning algorithm that matches sounds from the information to known sounds from the user.

As illustrated in this example, the user is engaged in a call using the headset 102. However, the user is not currently speaking during the call. The ANC manager 106 therefore detects that the user is not speaking during the call and does not initiate the ANC adjustment 124 and instead resumes the ANC 112. Because the user is currently listening on the call and not speaking, the ANC 112 provides the user with a comfortable call experience by canceling ambient noise 114 that is distracting to user listening on the call.

FIG. 4 illustrates an example 400 of adjusting noise cancellation based on detected speech, including dynamically adjusting the ANC based on noise identification, as described herein. The example 400 is an alternative implementation of the example 200 described with respect to FIG. 2. In this example 400, an ANC manager 106 is implemented in a headset 102, which is actively causing active noise cancellation (ANC) 120 that cancels the ambient noise 114 in the environment, resulting in the user being unable to hear external noise.

As illustrated in this example, a user is wearing the headset 102 to participate in a call. The headset 102 includes one or more speakers 116 for outputting audio playback from the call and a microphone 120 for receiving input audio to transmit for the call. For example, the headset 102 may be paired with a mobile device 108 that performs functions of the call, and the input audio is routed from the microphone 120 of the headset 102 while the output audio is routed to the one or more speakers 116 for playback. The headset 102 actively performs ANC 112 during the call.

In this example, for instance, the user is inside a home, and the ambient noise 114 includes air conditioning noise and dog barking noise. To cancel the ambient noise 114 so that it does not interfere with the user hearing audio from the call, the ANC manager 106 causes the headset 102 to emit sound waves that are opposite to ambient noise 114 in the environment, thereby cancelling at least a portion of the ambient noise 114.

However, it is now the user's turn to speak during the call. Although the ANC 112 helps reduce distractions by canceling the ambient noise 114 while the user is listening on the call, the lack of the ambient noise 114 creates an uncomfortable experience when the user is speaking on the call. This is because the user hears their voice in a vacuum unaccompanied by any other sound, which users typically do not enjoy. To solve this problem, the ANC manager 106 performs an ANC adjustment 124 while the user is speaking.

The ANC manager 106 first determines when the user is speaking on a call. In some example implementations, the ANC manager 106 employs a voice recognition model to differentiate user speech received at the microphone 120 from the ambient noise 114. As illustrated in this example, the user is engaged in a call using the headset 102. The user then says “Hi Joe, thanks for giving me a call . . . ” The ANC manager 106 therefore detects that the user is speaking during the call to initiate the ANC adjustment 124.

In contrast to the example 200 described with respect to FIG. 2 that involves pausing the ANC 112 completely while the user is speaking, this example implementation involves dynamically filtering the ambient noise 114 using the ANC 112 while the user is speaking. For instance, the low-level intrusive noises, such as the air conditioning noise, are desirable for the user to hear while speaking, while high-level intrusive noises, such as the dog barking noise, are distracting and are therefore not desirable for the user to hear while speaking. Therefore, in this example, the ANC manager 106 cancels the dog barking noise but does not cancel the air conditioning noise.

To differentiate which noises to filter, the ANC manager 106 in this example includes a noise identification module 402 to identify noises in the ambient noise 114. For example, the noise identification module 402 may leverage a machine learning model trained to identify specific noises based on an origin of the noise, a type of a noise, or based on another qualification of the noise. In some implementations, various types of noises may be categorized to predetermine which noises to cancel using the ANC 112. By identifying specific noises in in the ambient noise 114, the ANC manager 106 is then able to filter the ambient noise 114 by canceling some specific noises from the ambient noise 114 while allowing other specific noises to reach the user.

FIG. 5 illustrates an example 500 of adjusting noise cancellation based on detected speech, including dynamically adjusting the ANC based on a decibel level, as described herein. The example 500 is an alternative implementation of the example 200 described with respect to FIG. 2. In this example 400, an ANC manager 106 is implemented in a headset 102, which is actively causing active noise cancellation (ANC) 120 that cancels the ambient noise 114 in the environment, resulting in the user being unable to hear external noise.

As illustrated in this example, a user is wearing the headset 102 to participate in a call. The headset 102 includes one or more speakers 116 for outputting audio playback from the call and a microphone 120 for receiving input audio to transmit for the call. For example, the headset 102 may be paired with a mobile device 108 that performs functions of the call, and the input audio is routed from the microphone 120 of the headset 102 while the output audio is routed to the one or more speakers 116 for playback. The headset 102 actively performs ANC 112 during the call.

In this example, for instance, the user is inside a home, and the ambient noise 114 includes a mixture two noises: Noise A and Noise B. To cancel the ambient noise 114 so that it does not interfere with the user hearing audio from the call, the ANC manager 106 causes the headset 102 to emit sound waves that are opposite to ambient noise 114 in the environment, thereby cancelling at least a portion of the ambient noise 114.

However, it is now the user's turn to speak during the call. Although the ANC 112 helps reduce distractions by canceling the ambient noise 114 while the user is listening on the call, the lack of the ambient noise 114 creates an uncomfortable experience when the user is speaking on the call. This is because the user hears their voice in a vacuum unaccompanied by any other sound, which users typically do not enjoy. To solve this problem, the ANC manager 106 performs an ANC adjustment 124 while the user is speaking.

The ANC manager 106 first determines when the user is speaking on a call. In some example implementations, the ANC manager 106 employs a voice recognition model to differentiate user speech received at the microphone 120 from the ambient noise 114. As illustrated in this example, the user is engaged in a call using the headset 102. The user then says “Hi Joe, thanks for giving me a call . . . ” The ANC manager 106 therefore detects that the user is speaking during the call to initiate the ANC adjustment 124.

In contrast to the example 200 described with respect to FIG. 2 that involves pausing the ANC 112 completely while the user is speaking, this example implementation involves dynamically filtering the ambient noise 114 using the ANC 112 while the user is speaking. For instance, the low-decibel noises, such as the Noise A, are desirable for the user to hear while speaking, while high-decibel noises, such as the Noise B, are distracting and are therefore not desirable for the user to hear while speaking. Therefore, in this example, the ANC manager 106 cancels the Noise B but does not cancel the Noise A based on the corresponding decibel levels.

To differentiate which noises to filter, the ANC manager 106 in this example includes a decibel measurement module 502 to identify noises in the ambient noise 114 based on a decibel level. The decibel level is measured using a logarithmic scale to quantify the intensity of sound. For example, the noise identification module 402 may use a decibel formula to calculate a sound pressure level, which accounts for the human ear's sensitivity to different frequencies. In some implementations, a threshold decibel level is predetermined. By determining decibel levels for specific noises in in the ambient noise 114, the ANC manager 106 is then able to filter the ambient noise 114 by canceling noises from the ambient noise 114 having decibel levels above the threshold decibel level while allowing other noises having decibel levels below the threshold decibel level to reach the user.

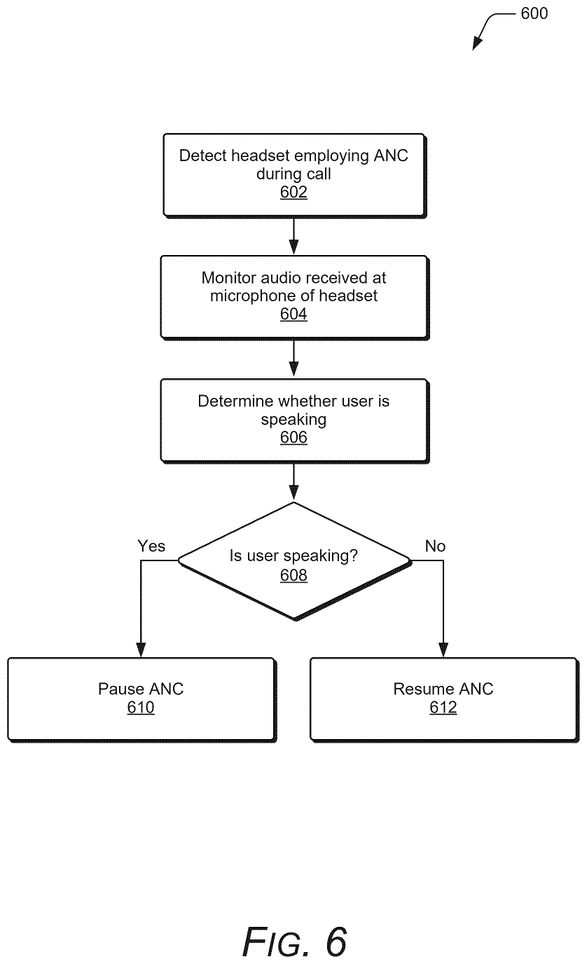

FIG. 6 is a flowchart illustrating an example method 600 of adjusting noise cancellation based on detected speech, as described herein. In this example at 602, a headset 102 is detected employing active noise cancelation (ANC) 112 during a call. The headset 102 includes a microphone 120, one or more speakers 116, and an ANC manager 106 in this example. For instance, the ANC manager 106 causes the headset 102 to emit sound waves that are opposite to ambient noise 114 in the environment, thereby cancelling at least a portion of the ambient noise 114. At 604, audio received at a microphone 120 of the headset 102 is monitored to, at 606, determine whether the user is speaking. For instance, the ANC manager 106 employs a voice recognition model to differentiate user speech from the ambient noise 114.

If the user is speaking, at 608, the ANC manager 106 initiates an ANC adjustment 124 in this example to pause the ANC 112 at 610. For instance, the ANC adjustment 124 pauses the ANC 112 while the user is speaking to that the ambient noise 114 is heard by the user while the user is speaking. If the user is not speaking, at 608, the ANC manager 106 resumes the ANC 112 at 612. For instance, the ANC 112 limits distractions while the user is listening on the call by canceling the ambient noise 114 heard by the user via the one or more speakers 116 of the headset 102.

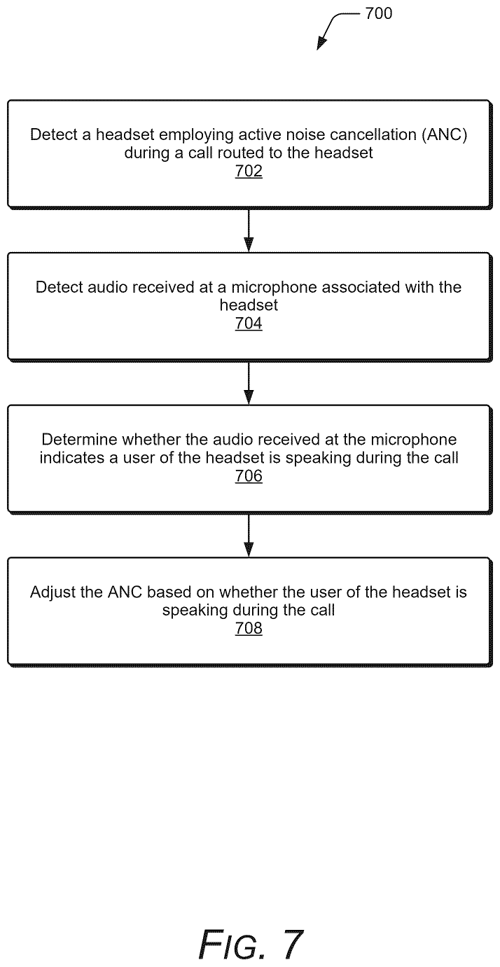

Example methods 700, 800, and 900 are described with reference to respective FIGS. 7, 8, and 9 in accordance with one or more implementations of adjusting noise cancellation based on detected speech, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 7 illustrates example method(s) 700 for adjusting noise cancellation based on detected speech. The order in which the method is described is not intended to be construed as a limitation, and any number or combination of the described method operations may be performed in any order to perform a method, or an alternate method.

At 702, a headset is detected employing active noise cancellation (ANC) during a call routed to the headset. For example, the ANC manager 106 detects a headset 102 employing ANC 112 during a call routed to the headset 102. In this example, the ANC 112 is configured to reduce ambient noise 114 from playback at speakers 116 of the headset 102.

At 704, audio received at a microphone associated with the headset is detected. For example, the ANC manager 106 detects audio received at a microphone 120 associated with the headset 102.

At 706, whether the audio received at the microphone indicates a user of the headset is speaking during the call is determined. For example, the ANC manager 106 determines whether the audio received at the microphone 120 indicates a user of the headset 102 is speaking during the call. In some implementations, the ANC manager 106 uses voice recognition to determine whether the audio received at the microphone 120 indicates the user of the headset 102 is speaking during the call.

At 708, the ANC is adjusted based on whether the user of the headset is speaking during the call. For example, the ANC manager 106 adjusts the ANC 112 based on whether the user of the headset 102 is speaking during the call. In some implementations, the ANC manager 106 pauses the ANC 112 while the user of the headset 102 is speaking during the call. Additionally or alternatively, the ANC manager 106 resumes the ANC 112 when the user of the headset 102 concludes speaking during the call. In some implementations, the ANC manager 106 adjusts the ANC 112 to filter specific noises from ambient noise in an environment of the headset 102 while the user of the headset is speaking during the call. In some examples, the specific noises are predetermined. In other implementations, the specific noises are above a threshold decibel level. Additionally or alternatively, the specific noises are below a threshold decibel level.

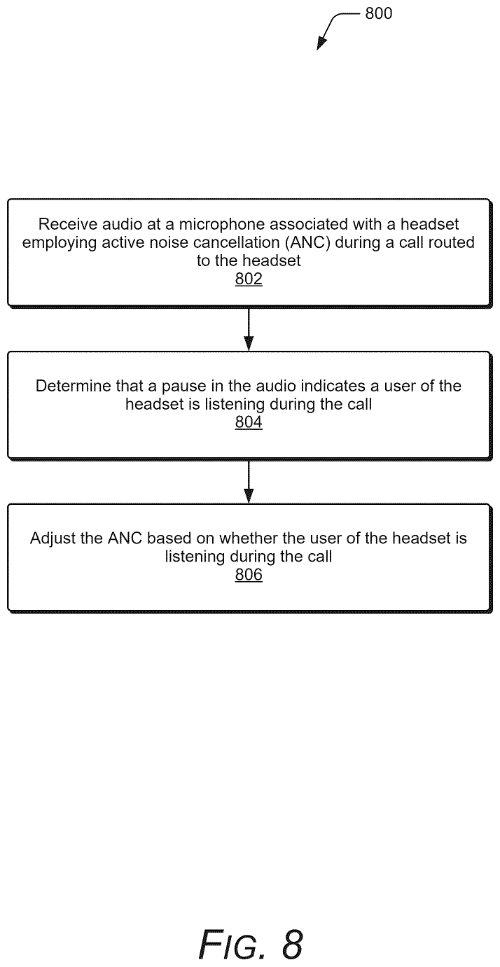

FIG. 8 illustrates example method(s) 800 for adjusting noise cancellation based on detected speech. The order in which the method is described is not intended to be construed as a limitation, and any number or combination of the described method operations may be performed in any order to perform a method, or an alternate method.

At 802, audio is received at a microphone associated with a headset employing active noise cancellation (ANC) during a call routed to the headset. For example, the ANC manager 106 receives audio at a microphone 120 associated with a headset 102 employing ANC 112 during a call routed to the headset 102. For example, the ANC 112 is configured to reduce ambient noise 114 from playback at speakers 116 of the headset 102.

At 804, a pause in the audio that indicates a user of the headset is listening during the call is determined. For example, the ANC manager 106 determines that a pause in the audio indicates a user of the headset 102 is listening during the call.

At 806, the ANC is adjusted based on whether the user of the headset is listening during the call. For example, the ANC manager 106 adjusts the ANC 112 based on whether the user of the headset 102 is listening during the call. In some implementations, the ANC manager 106 continues the ANC 112 while the user of the headset 102 is listening during the call. In other implementations, the ANC manager 106 adjusts the ANC 112 while the user of the headset 102 is speaking during the call. In some implementations, the ANC manager 106 adjusts the ANC 112 to filter specific noises from ambient noise 114 in an environment of the headset 102 while the user of the headset 102 is speaking during the call. In some examples, the specific noises are predetermined. Additionally or alternatively, the specific noises are above a threshold decibel level.

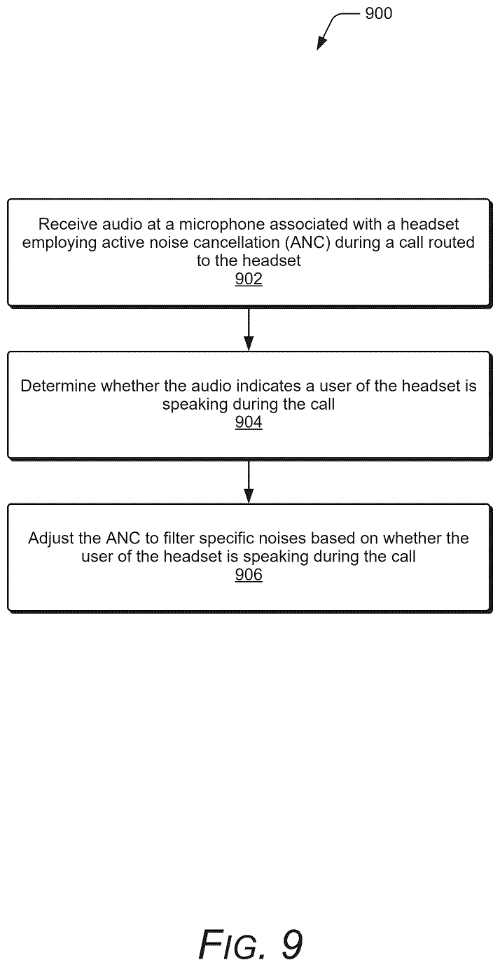

FIG. 9 illustrates example method(s) 900 for adjusting noise cancellation based on detected speech. The order in which the method is described is not intended to be construed as a limitation, and any number or combination of the described method operations may be performed in any order to perform a method, or an alternate method.

At 902, audio is received at a microphone associated with a headset employing active noise cancellation (ANC) during a call routed to the headset. For example, the ANC manager 106 receives audio at a microphone 120 associated with a headset 102 employing ANC 112 during a call routed to the headset 102.

At 904, whether the audio indicates a user of the headset is speaking during the call is determined. For example, the ANC manager 106 determines whether the audio indicates a user of the headset 102 is speaking during the call.

At 906, the ANC is adjusted to filter specific noises based on whether the user of the headset is speaking during the call. For example, the ANC manager 106 adjusts the ANC 112 to filter specific noises based on whether the user of the headset 102 is speaking during the call. In some implementations, the specific noises are predetermined. Additionally or alternatively, the specific noises are above a threshold decibel level. For example, the at least one processor is further configured to cause the ANC 112 to filter additional noises when the user of the headset 102 concludes speaking during the call.

FIG. 10 illustrates various components of an example device 1000, which can implement aspects of the techniques and features for adjusting noise cancellation based on detected speech, as described herein. The example device 1000 may be implemented as any of the devices described with reference to the previous FIGS. 1-10, such as any type of a wireless device, mobile device, mobile phone, flip phone, client device, companion device, display device, tablet, computing, communication, entertainment, gaming, media playback, and/or any other type of computing, consumer, and/or electronic device. For example, the mobile device 108 described with reference to FIGS. 1-10 may be implemented as the example device 1000.

The example device 1000 can include various, different communication devices 1002 that enable wired and/or wireless communication of device data 1004 with other devices. The device data 1004 can include any of the various devices data and content that is generated, processed, determined, received, stored, and/or communicated from one computing device to another. Generally, the device data 1004 can include any form of audio, video, image, graphics, and/or electronic data that is generated by applications executing on a device. The communication devices 1002 can also include transceivers for cellular phone communication and/or for any type of network data communication.

The example device 1000 can also include various, different types of data input/output (I/O) interfaces 1006, such as data network interfaces that provide connection and/or communication links between the devices, data networks, and other devices. The data I/O interfaces 1006 may be used to couple the device to any type of components, peripherals, and/or accessory devices, such as a computer input device that may be integrated with the example device 1000. The I/O interfaces 1006 may also include data input ports via which any type of data, information, media content, communications, messages, and/or inputs may be received, such as user inputs to the device, as well as any type of audio, video, image, graphics, and/or electronic data received from any content and/or data source.

The example device 1000 includes a processor system 1008 of one or more processors (e.g., any of microprocessors, controllers, and the like) and/or a processor and memory system implemented as a system-on-chip (SoC) that processes computer-executable instructions. The processor system 1008 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 1010. The example device 1000 may also include any type of a system bus or other data and command transfer system that couples the various components within the device. A system bus can include any one or combination of different bus structures and architectures, as well as control and data lines.

The example device 1000 also includes memory and/or memory devices 1012 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1012 include volatile memory and non-volatile memory, fixed and removable media devices, and any suitable memory device or electronic data storage that maintains data for computing device access. The memory devices 1012 can include various implementations of random-access memory (RAM), read-only memory (ROM), flash memory, and other types of storage media in various memory device configurations. The example device 1000 may also include a mass storage media device.

The memory devices 1012 (e.g., as computer-readable storage memory) provide data storage mechanisms, such as to store the device data 1004, other types of information and/or electronic data, and various device applications 1014 (e.g., software applications and/or modules). For example, an operating system 1016 may be maintained as software instructions with a memory device 1012 and executed by the processor system 1008 as a software application. The device applications 1014 may also include a device manager, such as any form of a control application, software application, signal-processing and control module, code that is specific to a particular device, a hardware abstraction layer for a particular device, and so on.

In this example, the device 1000 includes an ANC manager 1018 that implements various aspects of the described features and techniques described herein. The ANC manager 1018 may be implemented with hardware components and/or in software as one of the device applications 1014, such as when the example device 1000 is implemented as the mobile device 108 described with reference to FIGS. 1-10. An example of the ANC manager 1018 is the ANC manager 106 implemented by the mobile device 108, such as a software application and/or as hardware components in the mobile device. In implementations, the ANC manager 1018 may include independent processing, memory, and logic components as a computing and/or electronic device integrated with the example device 1000.

The example device 1000 can also include a microphone 1020 (e.g., to capture an audio recording) and/or camera devices 1022, as well as device sensors 1024, such as may be implemented as components of an inertial measurement unit (IMU). The device sensors 1024 may be implemented with various sensors, such as a gyroscope, an accelerometer, and/or other types of motion sensors to sense motion of the device. The device sensors 1024 can generate sensor data vectors having three-dimensional parameters (e.g., rotational vectors in x, y, and z-axis coordinates) indicating location, position, acceleration, rotational speed, and/or orientation of the device. The example device 1000 can also include one or more power sources 1026, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1000 can also include an audio and/or video processing system 1028 that generates audio data for an audio system 1030 and/or generates display data for a display system 1032. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1000. Alternatively, the audio system and/or the display system are external, peripheral components to the example device.

Although implementations for adjusting noise cancellation based on detected speech have been described in language specific to features and/or methods, the appended claims are not necessarily limited to the specific features or methods described. Rather, the specific features and methods are disclosed as example implementations for adjusting noise cancellation based on detected speech, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a client device, including at least one memory, and at least one processor coupled with the at least one memory and configured to cause the client device to detect a headset employing active noise cancellation (ANC) during a call routed to the headset, detect audio received at a microphone associated with the headset, determine whether the audio received at the microphone indicates a user of the headset is speaking during the call, and adjust the ANC based on whether the user of the headset is speaking during the call.

In some aspects, the techniques described herein relate to a client device, wherein the client device is further configured to pause the ANC while the user of the headset is speaking during the call.

In some aspects, the techniques described herein relate to a client device, wherein the client device is further configured to resume the ANC when the user of the headset concludes speaking during the call.

In some aspects, the techniques described herein relate to a client device, wherein the ANC is configured to reduce ambient noise from playback at speakers of the headset.

In some aspects, the techniques described herein relate to a client device, wherein the client device is further configured to adjust the ANC to filter specific noises from ambient noise in an environment of the headset while the user of the headset is speaking during the call.

In some aspects, the techniques described herein relate to a client device, wherein the specific noises are predetermined.

In some aspects, the techniques described herein relate to a client device, wherein the specific noises are above a threshold decibel level.

In some aspects, the techniques described herein relate to a client device, wherein the specific noises are below a threshold decibel level.

In some aspects, the techniques described herein relate to a client device, wherein the client device is further configured to use voice recognition to determine whether the audio received at the microphone indicates the user of the headset is speaking during the call.

In some aspects, the techniques described herein relate to a method performed by a client device, the method including receive audio at a microphone associated with a headset employing active noise cancellation (ANC) during a call routed to the headset, determine that a pause in the audio indicates a user of the headset is listening during the call, and adjust the ANC based on whether the user of the headset is listening during the call.

In some aspects, the techniques described herein relate to a method, further including continuing the ANC while the user of the headset is listening during the call.

In some aspects, the techniques described herein relate to a method, further including pausing the ANC while the user of the headset is speaking during the call.

In some aspects, the techniques described herein relate to a method, wherein the ANC is configured to reduce ambient noise from playback at speakers of the headset.

In some aspects, the techniques described herein relate to a method, wherein the client device is further configured to adjust the ANC to filter specific noises from ambient noise in an environment of the headset while the user of the headset is speaking during the call.

In some aspects, the techniques described herein relate to a method, wherein the specific noises are predetermined.

In some aspects, the techniques described herein relate to a method, wherein the specific noises are above a threshold decibel level.

In some aspects, the techniques described herein relate to a system, including at least one memory, and at least one processor coupled to the at least one memory and configured to cause the system to receive audio at a microphone associated with a headset employing active noise cancellation (ANC) during a call routed to the headset, determine whether the audio indicates a user of the headset is speaking during the call, and adjust the ANC to filter specific noises based on whether the user of the headset is speaking during the call.

In some aspects, the techniques described herein relate to a system, wherein the specific noises are predetermined.

In some aspects, the techniques described herein relate to a system, wherein the specific noises are above a threshold decibel level.

In some aspects, the techniques described herein relate to a system, wherein the at least one processor is further configured to cause the ANC to filter additional noises when the user of the headset concludes speaking during the call.

1. A client device, comprising:
at least one memory; and
at least one processor coupled with the at least one memory and configured to cause the client device to:
detect a headset employing active noise cancellation (ANC) during a call routed to the headset;
detect audio received at a microphone associated with the headset;
determine whether the audio received at the microphone indicates a user of the headset is speaking during the call; and
adjust the ANC based on whether the user of the headset is speaking during the call.

2. The client device of claim 1, wherein the client device is further configured to pause the ANC while the user of the headset is speaking during the call.

3. The client device of claim 1, wherein the client device is further configured to resume the ANC when the user of the headset concludes speaking during the call.

4. The client device of claim 1, wherein the ANC is configured to reduce ambient noise from playback at speakers of the headset.

5. The client device of claim 1, wherein the client device is further configured to adjust the ANC to filter specific noises from ambient noise in an environment of the headset while the user of the headset is speaking during the call.

6. The client device of claim 5, wherein the specific noises are predetermined.

7. The client device of claim 5, wherein the specific noises are above a threshold decibel level.

8. The client device of claim 5, wherein the specific noises are below a threshold decibel level.

9. The client device of claim 1, wherein the client device is further configured to use voice recognition to determine whether the audio received at the microphone indicates the user of the headset is speaking during the call.

10. A method performed by a client device, the method comprising:
receive audio at a microphone associated with a headset employing active noise cancellation (ANC) during a call routed to the headset;
determine that a pause in the audio indicates a user of the headset is listening during the call; and
adjust the ANC based on whether the user of the headset is listening during the call.

11. The method of claim 10, further comprising continuing the ANC while the user of the headset is listening during the call.

12. The method of claim 10, further comprising pausing the ANC while the user of the headset is speaking during the call.

13. The method of claim 10, wherein the ANC is configured to reduce ambient noise from playback at speakers of the headset.

14. The method of claim 10, wherein the client device is further configured to adjust the ANC to filter specific noises from ambient noise in an environment of the headset while the user of the headset is speaking during the call.

15. The method of claim 14, wherein the specific noises are predetermined.

16. The method of claim 14, wherein the specific noises are above a threshold decibel level.

17. A system, comprising:
at least one memory; and
at least one processor coupled to the at least one memory and configured to cause the system to:
receive audio at a microphone associated with a headset employing active noise cancellation (ANC) during a call routed to the headset;
determine whether the audio indicates a user of the headset is speaking during the call; and
adjust the ANC to filter specific noises based on whether the user of the headset is speaking during the call.

18. The system of claim 17, wherein the specific noises are predetermined.

19. The system of claim 17, wherein the specific noises are above a threshold decibel level.

20. The system of claim 17, wherein the at least one processor is further configured to cause the ANC to filter additional noises when the user of the headset concludes speaking during the call.
